(19) United States
(12) Patent Application Publication
(10) Pub. No.: US 2024/0362638 A1
(43) Pub. Date: Oct. 31, 2024

(54) USING ALERT STATISTICS TO SELECT ANOMALIES FOR REVIEW

(71) Applicant: Honeywell International Inc., Charlotte, NC (US)

(72) Inventor: Pavan Ravindra CHHATPAR, Atlanta, GA (US)

(21) Appl. No.: 18/306,729

(22) Filed: Apr. 25, 2023

(51) Int. Cl. G06Q 20/40

(52) U.S. Cl. CPC G06Q 20/4016

(57) ABSTRACT

A method is disclosed for detecting anomalous activity including receiving alert statistics associated with at least one anomaly detection strategy configured to identify anomalous activity in transaction records, determining for each anomaly detection strategy at least one effectiveness metric based on the alert statistics, determining a weighted score for each anomaly detection strategy based on the at least one effectiveness metric, receiving anomalous activity data indicative of one or more activities identified as potentially anomalous by each of the anomaly detection strategies, and determining a portion of the anomalous activity data identified by each of the anomaly detection strategies to be transmitted to an auditor for review based on the weighted score. The portion of potentially anomalous activities to be transmitted is substantially proportional to the weighted score for each of the anomaly detection strategies.

### TECHNICAL FIELD

Various embodiments of the present disclosure relate generally to systems and methods for detecting anomalous activity, and, more particularly, to selecting potentially anomalous activity for review based on alert statistics.

### BACKGROUND

Anomaly detection systems are used in various industries to identify business activity that is abnormal, skirts established business practices, is fraudulent, or the like. For example, anomaly detection systems may be used to identify transactions that are performed outside of established systems and therefore are not properly recorded and/or vetted. The use of a sound anomaly detection system may identify such activity for correction and remediation. Further, implementation of an anomaly detection system may exhibit a passive deterrent effect of discouraging workers from circumventing established business practices.

Automated anomaly detection systems are typically used in environments where available human and/or computational resources are insufficient to practically analyze each individual activity that falls under the scope of review for anomalies. Even if sufficient resources are available, it may be inefficient or otherwise undesirable to analyze each individual activity. Automated anomaly detection systems are used in these situations to initially flag activities that may be anomalous based on predetermined criteria. Thus, anomaly detection systems can reduce the number of activities that need to be more thoroughly analyzed by human auditors.

Once an activity is identified by an anomaly detection system as possibly anomalous, subsequent analysis (typically by a human reviewer) may be performed to verify that the activity is truly anomalous (i.e. not a false positive result), to determine why the activity occurred, and/or to determine steps to rectify the anomalous activity.

The efficiency of anomaly detection systems may be characterized by the occurrence of false positive results—i.e. an activity identified by the anomaly detection system that is not actually anomalous. A high rate of false positives is inefficient, as resources are wasted performing subsequent analysis on activity that is not actually anomalous. Various detection strategies have been proposed for flagging anomalous activities, which have varying rates of producing of false positive results. However, certain detection strategies may lose effectiveness over time, resulting in reduced efficacy of the system. Furthermore, simply assessing the rate of false positive results may not provide a complete indication of the effectiveness of the detections strategies and systems.

The present disclosure is directed to overcoming one or more of these above-referenced challenges.

### SUMMARY OF THE DISCLOSURE

In some aspects, the techniques described herein relate to a method for detecting anomalous activity. In embodiments, the method comprises receiving, by at least one processor, alert statistics associated with at least one anomaly detection strategy configured to identify anomalous activity in transaction records; determining, by at least one processor, for each of the anomaly detection strategies, at least one effectiveness metric based on the alert statistics; determining, by at least one processor, a weighted score for each of the anomaly detection strategies based on the at least one effectiveness metric; receiving, by at least one processor, anomalous activity data indicative of one or more activities identified as potentially anomalous by each of the anomaly detection strategies; and determining, by at least one processor, a portion of the anomalous activity data identified by each of the anomaly detection strategies to be transmitted to an auditor for review based on the weighted score. The portion of potentially anomalous activities to be transmitted is substantially proportional to the weighted score for each of the anomaly detection strategies.

In some embodiments, the at least one effectiveness metric includes normalized discounted cumulative gain score representative of ranking quality of an anomaly detection strategy.

In some embodiments, the at least one effectiveness metric includes hit rate representative of a rate at which an anomaly detection strategy identifies true positive results.

In some embodiments, a number of potentially anomalous activities to be reviewed is at least one for each of the anomaly detection strategies.

In some embodiments, the alert statistics for each of the anomaly detection strategies comprise at least one of a number of true positive results identified by each of the anomaly detection strategies, a number of false positive results identified by each of the anomaly detection strategies, and rankings of the results identified by each of the anomaly detection strategies.

In some embodiments, the method further comprises receiving, by at least one processor, auditor review data associated with the portion of potentially anomalous activities transmitted to the auditor; and updating, by at least one processor, the alert statistics based on the auditor review data.

In some embodiments, the method further comprises determining, by at least one processor, that one of the at least one anomaly detection strategies is an ineffective strategy based on the alert statistics; and replacing, by at least one processor, the ineffective strategy with a new anomaly detection strategy.

Other embodiments of the present disclosure are directed to a computer system for detecting anomalous activity. The computer system comprises at least one memory having processor-readable instructions stored therein, and at least one processor configured to access the memory and execute the processor-readable instructions, which when executed by the processor configure the processor to perform a plurality of functions. The plurality of functions comprises functions for receiving alert statistics associated with at least one anomaly detection strategy configured to identify anomalous activity in transaction records; determining, for each of the anomaly detection strategies, at least one effectiveness metric based on the alert statistics; determining a weighted score for each of the anomaly detection strategies based on the at least one effectiveness metric; receiving anomalous activity data indicative of one or more activities identified as potentially anomalous by each of the anomaly detection strategies; and determining a portion of the anomalous activity data identified by each of the anomaly detection strategies to be transmitted to an auditor for review based on the weighted score. The portion of potentially anomalous activities to be transmitted is substantially proportional to the weighted score for each of the anomaly detection strategies.

In some embodiments, the at least one effectiveness metric includes normalized discounted cumulative gain score representative of ranking quality of an anomaly detection strategy.

In some embodiments, the at least one effectiveness metric includes hit rate representative of a rate at which an anomaly detection strategy identifies true positive results.

In some embodiments, a number of potentially anomalous activities to be reviewed is at least one for each of the anomaly detection strategies.

In some embodiments, the alert statistics for each of the anomaly detection strategies comprise at least one of a number of true positive results identified by each of the anomaly detection strategies, a number of false positive results identified by each of the anomaly detection strategies, and rankings of the results identified by each of the anomaly detection strategies.

In some embodiments, the plurality of functions further comprise receiving auditor review data associated with the portion of potentially anomalous activities transmitted to the auditor, and updating the alert statistics based on the auditor review data.

In some embodiments, the plurality of functions further comprise determining that one of the at least one anomaly detection strategies is an ineffective strategy based on the alert statistics, and replacing the ineffective strategy with a new anomaly detection strategy.

Other embodiments of the present disclosure are directed to a non-transitory computer-readable medium containing instructions for detecting anomalous activity. The non-transitory computer-readable medium stores instructions that, when executed by at least one processor, configure the at least one processor to perform receiving alert statistics associated with at least one anomaly detection strategy configured to identify anomalous activity in transaction records; determining, for each of the anomaly detection strategies, at least one effectiveness metric based on the alert statistics; determining a weighted score for each of the anomaly detection strategies based on the at least one effectiveness metric; receiving anomalous activity data indicative of one or more activities identified as potentially anomalous by each of the anomaly detection strategies; and determining a portion of the anomalous activity data identified by each of the anomaly detection strategies to be transmitted to an auditor for review based on the weighted score. The portion of potentially anomalous activities to be transmitted is substantially proportional to the weighted score for each of the anomaly detection strategies.

In some embodiments, the at least one effectiveness metric includes normalized discounted cumulative gain score representative of ranking quality of an anomaly detection strategy.

In some embodiments, the at least one effectiveness metric includes hit rate representative of a rate at which an anomaly detection strategy identifies true positive results.

In some embodiments, a number of potentially anomalous activities to be reviewed is at least one for each of the anomaly detection strategies.

In some embodiments, the instructions further configure the at least one processor to perform receiving auditor review data associated with the portion of potentially anomalous activities transmitted to the auditor, and updating the alert statistics based on the auditor review data.

In some embodiments, the instructions further configure the at least one processor to perform determining that one of the at least one anomaly detection strategies is an ineffective strategy based on the alert statistics, and replacing the ineffective strategy with a new anomaly detection strategy.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for detecting anomalous activity, according to one or more embodiments.

FIG. 2 depicts an architecture for generating and utilizing effectiveness metrics to distribute potentially anomalous transaction records to an auditor, according to one or more embodiments.

FIG. 3 depicts a table including exemplary anomaly detection data and alert statistics associated with various anomaly detection strategies, according to one or more embodiments.

FIG. 4 depicts a flowchart of a method for detecting anomalous activity, according to one or more embodiments.

FIG. 5 depicts a flowchart of a method for detecting anomalous activity, according to one or more embodiments.

FIG. 6 depicts an implementation of a computer system that may execute techniques presented herein, according to one or more embodiments.

### DETAILED DESCRIPTION OF EMBODIMENTS

Various embodiments of the present disclosure relate generally to systems and methods for detecting anomalous activity. More particularly, the systems and methods described herein generate effectiveness metrics to objectively score various automatic anomaly detection strategies, so that effective detection strategies are favored to pre-screen transaction data for auditors. The various anomaly detection strategies are applied to transaction data to identify potentially anomalous activity, and the potentially anomalous activity is then transmitted to an auditor for review. Anomaly detection strategies are utilized proportionally to their assessed effectiveness, meaning that more results from effective strategies are transmitted to the auditor for review, whereas less results from ineffective strategies are transmitted to the auditor for review. As such, the auditor spends more time reviewing transaction data that is more likely to contain true anomalies, thereby optimizing the use of auditor time. Additionally, computational resources such as processing power and memory are conserved because less data reviewed by ineffective anomaly detection strategies in transferred between devices (e.g. from a database containing transaction data to local devices used by the auditor).

Furthermore, in some embodiments, ineffective anomaly detection strategies may be replaced with more effective strategies. Thus, computational resources are optimized by discontinuing use of ineffective strategies that identify a relatively low amount of true anomalies relative to the computational resources that are consume.

Subject matter will now be described more fully hereinafter with reference to the accompanying drawings, which form a part hereof, and which show, by way of illustration, specific exemplary embodiments. An embodiment or implementation described herein as “exemplary” is not to be construed as preferred or advantageous, for example, over other embodiments or implementations; rather, it is intended reflect or indicate that the embodiment(s) is/are “example” embodiment(s). Subject matter be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). Furthermore, the method presented in the drawings and the specification is not to be construed as limiting the order in which the individual steps may be performed. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” or “in some embodiments” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

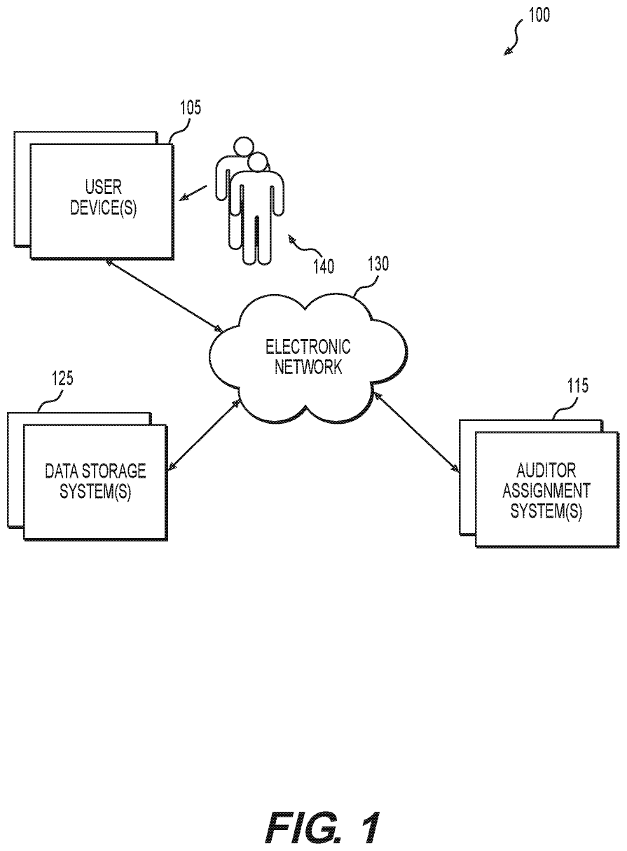

Referring now to the accompanying drawings, FIG. 1 depicts an exemplary environment 100 that may be utilized with techniques presented herein. One or more user devices 105 used by one or more users (e.g., auditors 140 of transaction data), one or more auditor assignment system(s) 115, and one or more data storage systems 125 may communicate across an electronic network 130. As will be discussed herein, auditor assignment system(s) 115 may communicate with one or more other components of environment 100 across electronic network 130 in order to analyze the effectiveness of one or more strategies for detecting potentially anomalous activity, and to determine potentially anomalous activity for auditor(s) 140 to review.

In some embodiments, components of environment 100 are associated with a common entity, e.g., an accounting department, auditing department, ombudsman department or the like. In some embodiments, one or more of the components of environment 100 is associated with a different entity than another. The systems and devices of environment 100 may communicate in any arrangement.

User device 105 may be configured to enable auditor(s) 140 to access and/or interact with other systems in environment 100. Particularly, user device 105 may be configured to receive transaction data identified by one or more components of environment 100 as potentially anomalous, so that auditor 140 may review such transaction data to determine whether an anomaly actually exists. User device 105 may be, for example, a computer system such as, for example, a desktop computer, a mobile device, a tablet, a facility terminal, etc. In some embodiments, user device 105 may include one or more electronic application(s), e.g., a program, plugin, browser extension, etc., installed on a memory of user device 105. In some embodiments, the electronic application(s) may be associated with one or more of the other components in environment 100. For example, the electronic application(s) may include one or more of system control software, system monitoring software, software development tools, etc.

Data storage system 125 may include a server system, an electronic medical data system, computer-readable memory such as a hard drive, flash drive, disk, etc. In some embodiments, data storage system 125 includes and/or interacts with an application programming interface for exchanging data to other systems, e.g., one or more of the other components of the environment. Data storage system 125 may include and/or act as a repository for transaction data to be reviewed/audited, and/or alert statistics related to anomaly detection strategies described in greater detail herein.

In various embodiments, electronic network 130 may be a wide area network (“WAN”), a local area network (“LAN”), personal area network (“PAN”), or the like. In some embodiments, electronic network 130 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

Although depicted as separate components in FIG. 1, it should be understood that a component or portion of a component in environment 100 may, in some embodiments, be integrated with or incorporated into one or more other components. For example, auditor assignment system(s) 115 may be integrated into data storage system 125. In some embodiments, operations or aspects of one or more of the components discussed above may be distributed amongst one or more other components. Any suitable arrangement and/or integration of the various systems and devices of environment 100 may be used.

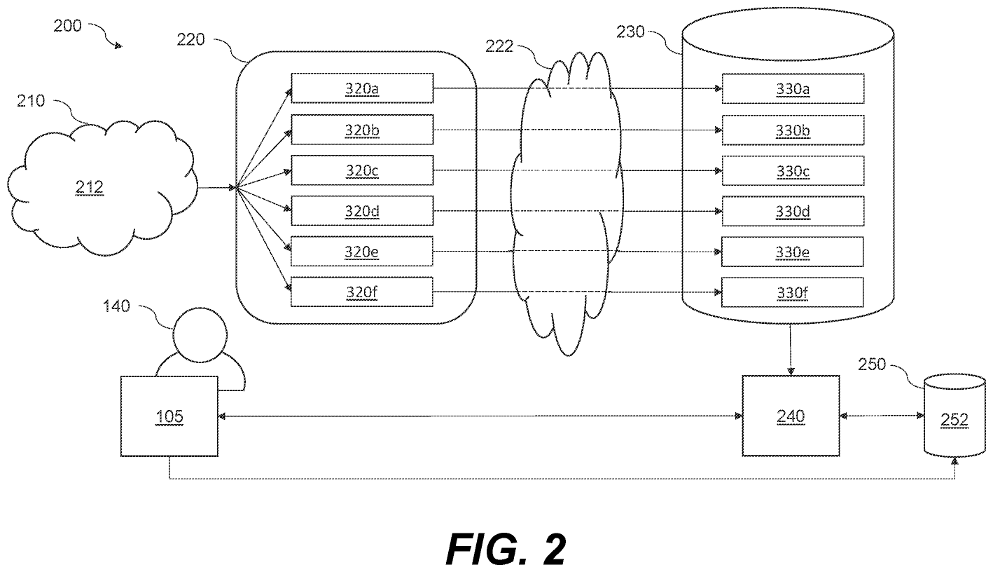

Referring now to FIG. 2, architecture 200 for generating and utilizing effectiveness metrics to distribute potentially anomalous transaction records to an auditor is illustrated in accordance with an embodiment of the present disclosure. Architecture includes data storage 210 including transaction data 212 related to one or more transactions that are to be reviewed for anomalous activity. Transaction data 212 may include, for example, purchase orders, invoices, vendor correspondence, and other data generated as a result of performing a transaction. In some embodiments, data storage 210 may be included in data storage device(s) 125 of FIG. 1. Although the embodiments described herein are directed to detecting anomalous activity occurring in transaction data 212, one skilled in the art will appreciate that the principles of the present disclosure may be readily extended to the detection of anomalies in other processes, with transaction data 212 being substituted for the relevant data type(s) for such processes.

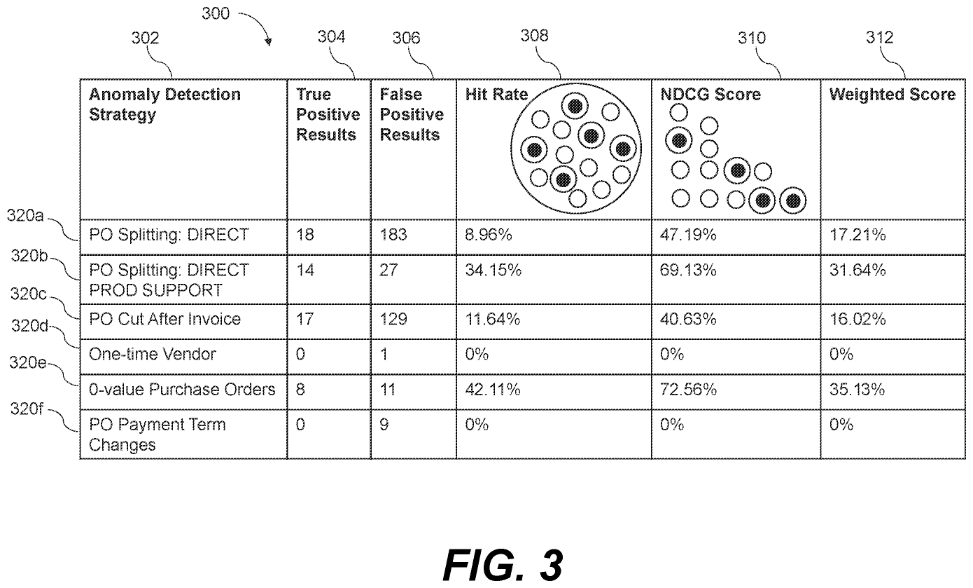

With continued reference to FIG. 2, architecture 200 further includes anomaly detection engine 220 which receives transaction data 212 and automatically reviews transaction data 212 to detect potentially anomalous activity. Anomaly detection engine 220 includes a plurality of anomaly detection strategies 320a-320f, each of which may use a different analyzation technique, such as identifying the presence of predetermined criteria in transaction data 212, to identify anomalous activity. For example, the criteria utilized by one or more of anomaly detection strategies 320a-320f may be indicative that an activity (e.g., a transaction) has been performed outside normal accounting practices (e.g., under the table or off the books). In some embodiments, anomaly detection engine 220 may be a component of auditor assignment system(s) 115 of FIG. 1. In the illustrated embodiment, anomaly detection engine 220 includes six different anomaly detection strategies, each utilizing a different technique to identify potentially anomalous activity within transaction data 212. For example, each of anomaly detection strategies 320a-320f may be configured to identify a different criteria relating to a purchase order, invoice, vendor selection, or the like that is indicative of the underlying transaction data 212 being potentially anomalous. Particular details of each of anomaly detection strategies 320a-320f are described herein in reference to FIG. 3.

In practice, anomaly detection strategies 320a-320f may not be expected to be accurate 100% of the time. That is, some activities identified by anomaly detection strategies 320a-320f as being potentially anomalous are expected to be false positive results. Nevertheless, anomaly detection strategies 320a-320f may save significant amounts of human time and computational resources (e.g. processor and/or memory resources) by determining portions of the transaction data that likely do not include anomalous activity. Anomaly detection strategies 320a-320f may be utilized to screen transaction data 212 to find only potentially anomalous activity that should be subjected to a detailed review by auditor(s) 140, so that such review is not wasted on transaction data 212 that is unlikely to include an anomaly. Anomaly detection strategies 320a-320f may be particularly valuable where large amounts of transaction data needs to be analyzed in a relatively short amount of time, where detailed auditing of all of the transaction data is not viable.

In some embodiments, each of anomaly detection strategies 320a-320f may be implemented on a unique portion of transaction data 212. In other embodiments, multiple anomaly detection strategies may be implemented on the same portions of transaction data 212 to decrease the likelihood of potentially anomalous activity being missed.

In some embodiments, anomaly detection strategies 320a-320f may be generated based on learned associations (from either or both manual or computer-based auditing processes) between markers within transaction data 212 and anomalous activities. New anomaly detection strategies may be routinely implemented based on trends in verified anomalous activities, as will be described in greater detail herein.

With continued reference to FIG. 2, anomaly detection engine 220 generates and/or transmits anomalous activity data 222 to audit database 230. Anomalous activity data 222 includes activity within transaction data 212 that anomaly detection engine 220 identified as being potentially anomalous, based on the criteria utilized by anomaly detection strategies 320a-320f. Audit database 230 includes a plurality of sub-databases 330a-330f each respectively associated with one of anomaly detection strategies 320a-320f. Activity determined to be potentially anomalous by each of anomaly detection strategies 320a-320f is stored on and/or written to the respective sub-database 330a-330f, so that potentially anomalous activity is linked to the anomaly detection strategy 320a-320f by which that activity was identified. In other embodiments, anomalous activity data 222 includes metadata indicating which anomaly detection strategies 320a-320f identified the potentially anomalous activity. In some embodiments, audit database 230 may be included in data storage device(s) 125 of FIG. 1.

With continued reference to FIG. 2, architecture 200 further includes weighting engine 240 which transmits selected portions of anomalous activity data 222 from audit database 230 to one or more user devices 105 associated with one or more auditors 140. In some embodiments, the selected portion of anomalous activity data 222 may be based on various effectiveness metrics of each of anomaly detection strategies 320a-320f. In particular, weighting engine 240 may be configured to transmit a higher proportion of data from sub-databases 330a-330f associated with anomaly detection strategies 320a-320f which are more effective at identifying true anomalous activity, as will be described in greater detail herein with reference to FIG. 3 et al. For example, if anomaly detection 320b is determined to be more effective than anomaly detection strategy 320a, a greater portion of data from sub-database 330b than from sub-database 330a will be transmitted by weighting engine 240. In some embodiments, weighting engine 240 may be a component of auditor assignment system(s) 115 of FIG. 1.

With continued reference to FIG. 2, architecture 200 further includes historical database 250 which stores data relating to the effectiveness of each of anomaly detection strategies 320a-320f. In some embodiments, historical database 250 may be included in data storage device(s) 125 of FIG. 1. Historical database 250 may include alert statistics 252 associated with each of anomaly detection strategies 320a-320f. Alert statistics 252 may include, for each anomaly detection strategy 320a-320f, historical data relating to the number of activities identified by that activity as being potentially anomalous; a number of those identified activities that were determined to be actually anomalous upon review by auditor(s) 140 (i.e., true positive results); and a number of those identified activities that were determined to be not anomalous upon review by auditor(s) 140 (i.e., false positive results).

Alert statistics 252 may include effectiveness metrics indicative of the effectiveness with which each anomaly detection strategy 320a-320f identifies actually anomalous activity (i.e. true positive results) within transaction data 212. Further details of effectiveness metrics, which may be generated, for example, by weighting engine 240, are described herein within reference to FIG. 3.

Alert statistics 252 contained in historical database 250 may be updated each time auditor(s) 140 reviews results provided by weighting engine 240. For example, alert statistics 252 may be updated to reflect a determination by auditor(s) 140 that potentially anomalous activity identified by anomaly detection strategy 320a-320f is a true positive result or a false positive result. Thus, alert statistics 252 may remain current so that determinations made by weighting engine 240 are reflective of up to date data.

In some embodiments, weighting engine 240 may be configured to utilize historical database 250 to monitor the effectiveness of anomaly detection strategies 320a-320f, and to replace ineffective anomaly detection strategies with new, more effective detection strategies. In particular, weighting engine 240 may identify ineffective anomaly detection strategies based on alert statistics 252. In some embodiments, weighting engine 240 may remove ineffective strategies from anomaly detection engine 220, and/or add new anomaly detection strategies to anomaly detection engine 220.

FIG. 3 is a table 300 including exemplary alert statistics 252 associated with anomaly detection strategies 320a-320f and assessed using various metrics. As described with reference to FIG. 2, anomaly detection strategies 320a-320f may utilize various analyzation techniques to predict whether an activity is likely to be anomalous. For example, detection strategy 320a, namely “Purchase Order Splitting: DIRECT”, is configured to determine the presence of a potential anomaly based on criteria of a large direct purchase order being split into multiple smaller purchase orders. Splitting a purchase order may be performed to circumvent rules that require purchase orders above a predetermined threshold to be approved. Detection strategy 320b, namely “Purchase Order Splitting: DIRECT PRODUCT SUPPORT”, is configured to determine the presence of a potential anomaly based on the criteria of a large direct product support purchase order being split being split into multiple smaller purchase orders. Splitting a purchase order may be performed to circumvent rules that require purchase orders above a predetermined threshold to be approved. Purchase order splitting is analyzed separately for “Purchase Order Splitting: DIRECT” and “Purchase Order Splitting: DIRECT PRODUCT SUPPORT” because purchase orders of each type would be reviewed by different auditors, and it would not be possible to mix these two types of purchase orders to avoid approval processes. Detection strategy 320c, namely “Purchase Cut After Invoice”, is configured to determine the presence of a potential anomaly based on the criteria of a purchase order being cut after the invoice for that purchase order has been issued and/or received. Detection strategy 320d, namely “One-time Vendor”, is configured to determine the presence of a potential anomaly based on the criteria of a purchase order being sent to and/or fulfilled by an otherwise unused vendor. Detection strategy 320e, namely “Zero-value Purchase Order”, is configured to determine the presence of a potential anomaly based on the criteria of a purchase order having a zero balance. Detection strategy 320f, namely “Purchase Order Payment Term Changes”, is configured to determine the presence of a potential anomaly based on the criteria of one or more terms of a purchase order changing after approval and/or issuance.

Table 300 illustrates the effectiveness of each of detection strategies 320a-320f at correctly identifying anomalous activities based on historical data 252 (see FIG. 2). Column 304 of table 300 includes the number of true positive results identified by each of anomaly detection strategies 320a-320f. As described herein, true positive results represent activities identified by detection strategies 320a-320f as potentially being anomalous (i.e., those activities that meet a criteria for potentially being anomalous) that were verified as anomalous upon further review (e.g., by auditor 140). Column 306 of table 300 includes the number of false positive results identified by each of anomaly detection strategies 320a-320f. As described herein, false positive results represent activities identified by detection strategies 320a-320f as potentially being anomalous (i.e., those activities that meet a criteria for potentially being anomalous) that were verified as anomalous upon further review (e.g., by auditor 140), but which were subsequently determined to not be anomalous upon such further review (e.g. by auditor 140). The total number of activities identified by each of anomaly detection strategies 320a-320f as being potentially anomalous is thus the sum of the values in column 304 and column 306.

For example, of the activities identified by detection strategy 320a (“Purchase Order Splitting: DIRECT”) as being potentially anomalous, 18 were determined to be true positive results after subsequent analysis (see column 304), and 183 were determined to be false positive results after subsequent analysis (see column 306). The total number of activities identified by detection strategy 320a is 201 (18 true positive results plus 183 false positive results).

Referring still to FIG. 3, one or more effectiveness metrics may be utilized to determine the effectiveness with which each of the anomaly detection strategies 320a-320f correctly identifies anomalous activities—i.e. the effectiveness with which detection strategies 320a-320f identify true positive results. Table 300 illustrates exemplary data for two effectiveness metrics, namely a hit rate presented in column 308 of table 300, and a normalized discounted cumulative gain (“NDCG”) score presented in column 310 of table 300.

Hit rate is a measure of the ratio or percentage of true positive results relative to the number of records identified by each anomaly detection strategy as being potentially anomalous. For example, detection strategy 320a (“Purchase Order Splitting: DIRECT”) correctly determined that 18 activities were anomalous (i.e. true positive results) out of the total of 201 identified activities. Thus, the hit rate of detection strategy 320a is 8.96% (18=201).

NDCG score is a measure of the ranking quality of results based on the order that relevant results (i.e. true positive results) are presented to auditor(s) 140. Thus, NDCG score is not only dependent on the relative number of true positive to false positive results, but also on the order in which the results are presented. The NDCG score is higher when results are presented/transmitted in a manner such that the auditor(s) 140 observes the true positive results relatively earlier. For example, a hypothetical anomaly detection strategy that includes three (3) true positive results (TP) and three (3) false positive results (FP) will have the highest NDCG score if the results were presented in the order TP, TP, TP, TF, TF, TF. Conversely, the NDCG score would be lowest if the results were presented in the order TF, TF, TF, TP, TP, TP. All other possible orders, such as TP, TF, TP, TF, TP, TF, would have an NDCG score between the highest and lowest score. Moreover, if auditor(s) 140 is presented with a predetermined number of results (n) to review out of a total number of results (m), NDCG score will be higher if the results (n) include more true positives. For example, if auditor(s) 140 is tasked with viewing three (3) results of the group of six (6) results consisting of TP, TP, TP, TF, TF, TF, the NDCG score would be highest if the three (3) results assigned to auditor(s) 140 to review were TP, TP, TP.

The NDCG score for each anomaly detection strategy 320a-320f shown in column 310 of table 300 is based on a particular order in which the true positive results and false positive results are presented. For example, the NDCG of 47.19% for anomaly detection strategy (“Purchase Order Splitting: DIRECT”) is dependent on the order in which the 18 true positive results and 183 false positive results are presented to the auditor. The NDCG score would be different than illustrated in FIG. 3 if the 18 true positive results and 183 false positive results were presented in a different order.

Because ordering of the results is a factor of determining NDCG score, NDCG score is not necessarily consistent with hit rate for the transaction data. That is, an anomaly detection strategy with a relatively low hit rate may have a relatively high NDCG score, and vice versa. For example, an anomaly detection strategy producing a high percentage of false positive results may be still have a relatively high NDCG score if the true positive results are presented to auditor(s) 140 relatively early within the results (i.e., the results are frontloaded with the true positive results). For example, anomaly detection strategy 320a has a hit rate of 8.96% but an NDCG score of 47.19%, indicating that anomaly detection strategy 320a is relatively effective at presenting auditor\(s) 140 with true positive results, even though anomaly detection strategy 320a produces a significant number of false positive results.

NDCG score may be a particularly useful metric when all results cannot be subjected to timely review by auditor(s) 140, such as when a large amount of transaction data is received in a short time. In such situations, only a portion (e.g., a preliminary initial set) of the identified results may be transmitted to auditor(s) 140 for review. If the NDCG score of that anomaly detection system is relatively high, a significant portion of the true positive results will be presented in the preliminary set of results, rather than being randomly distributed throughout the results as a whole. Thus, anomaly detection systems having a relatively high NDCG score may be preferred because a significant portion of the true positive results will be presented to auditor(s) 140, as compared to an anomaly detection system having a relatively lower NDCG score, within a preliminary set of results.

For example, anomaly detection strategy 320a as illustrated in table 300 detected 201 potentially anomalous activities (18 true positive results plus 183 false positive results), of which 8.96% were true positive results (18 true positive results=201 total results). Thus, if the results are presented without ranking, a preliminary set of results would be expected to include about 8.96% true positive results, the same as the percentage of true positive results over all 201 results. However, if anomaly detection strategy 320a effectively ranks the results (and thus has a relatively high NDCG score), the preliminary set of results will include more than 8.96% true positive results. As such, auditor(s) 140 reviewing only the preliminary set of results will encounter a disproportionately high number of true positive results relative to a random distribution of results, and therefore auditor(s) 140 will not expend time reviewing results that are likely to be false positive results.

Mathematically, NDCG is a sum of graded relevance values of all results in a set of data, normalized against the maximum possible sum of graded relevance values. NDCG is a subset of discounted cumulative gain (DCG), and in particular is a function of DCG and ideal discounted cumulative gain (IDCG). Namely, NDCG is calculated as shown below in Equation 1.

$$D C G = \frac{D C G}{I D C G} . \qquad Equation 1$$

DCG is calculated as shown below in Equation 2.

$$C G = {\sum }_{i = 1}^{p} \frac{{rel}_{i}}{{log}_{2} ( i + 1 )} , \qquad Equation 2$$

where ρ is a given rank position, and relᵢ is the graded relevance of the result at position i.

IDCG is calculated as shown below in Equation 3.

$$D C G = {\sum }_{i = 1}^{\vert {REL}_{p} \vert} \frac{{rel}_{i}}{{log}_{2} ( i + 1 )} , \qquad Equation 3$$

where RELₚ represents the list of relevant results (ordered by their relevance) in the dataset up to position pᵢ and relᵢ is the graded relevance of the result at position i.

In calculation of DCG (Equation 2) and IDCG (Equation 3), graded relevance (relᵢ) is a value given indicative of the relevance of each result. For a true positive result, graded relevance (relᵢ) is assigned a value of 1; whereas for a false positive results, graded relevance (relᵢ) is assigned a value of 0. In the context of the present disclosure, relᵢ may be 1 for a true positive result and 0 for a false positive result, so the NDCG score is higher for detection strategies that rank true positive results more highly that false positive results (i.e. NDCG score is higher when the detection strategy presents true positives to auditor 140 earlier in the overall results). As may be appreciated from Equations 1-3, a true positive result (relᵢ=1) for the first result (i=1) presented to auditor(s) 140 contributes more to the overall NDCG score than a true positive result (relᵢ=1) for the second result (i=2), which in turn contributes more to the overall NDCG score than a true positive result (relᵢ=1) for the third result (i=3), and so on.

In some embodiments, certain highly relevant results may be assigned a graded relevance (relᵢ) of greater than 1. For example, if review of an anomaly leads to executive level actions to be performed in the course of corrective measures, the graded relevance (relᵢ) may be assigned a value of 2, a value of 3, etc. to weight that result based on its increased significance.

Inherently, the value for NDCG as calculated by Equation 1 falls in a range of 0 to 1, with 1 representing all of the results being true positive results. Thus, NDCG can be readily expressed as a percentage, as shown in column 310 of table 300.

Referring still to FIG. 3, column 312 of table 300 provides a weighted score for each of anomaly detection strategies 320a-320f. The weighted score for each of anomaly detection strategies 320a-320f is determined based on the effectiveness metrics, namely hit rate (column 308) and NDCG score (column 310). In some embodiments, hit rate and NDCG score are weighted equally in determining the weighted score. That is, hit rate and NDCG score are each given 50% weight in determining the weighted score. In some embodiments, weighted scores are normalized so that a sum of the weighted scores for each of anomaly detection strategies 320a-320f equals 100% (i.e. the sum of the individual values of column 312 is 100%). Thus, to determine the final weighted score in column 312 for each anomaly strategy 320a-320f, the hit rate and NDCG score are added, divided by 2, and normalized. For example, for anomaly detection strategy 320a, hit rate and NDCG score are added and divided by two as follows: (8.96%+47.14%)/2=28.08%. The corresponding values for anomaly detection strategies 320b-320f are, 51.64%, 26.14%, 0%, 57.34%, and 0%, respectively. The sum of these values is 163.19% (28.08%+51.64%+26.14%+0%+57.34%+0%). Normalizing these values to a scale of 100% to determine the final weighted score in column 312 is achieved by dividing the value for each anomaly detection strategy 320a-320f by the sum of 163.19%. For example, the weighted score for anomaly detection strategy 320a is 17.21% (28.08/163.19); the weighted score for anomaly detection strategy 320b is 31.64% (51.64/163.19), and so on as shown in column 312.

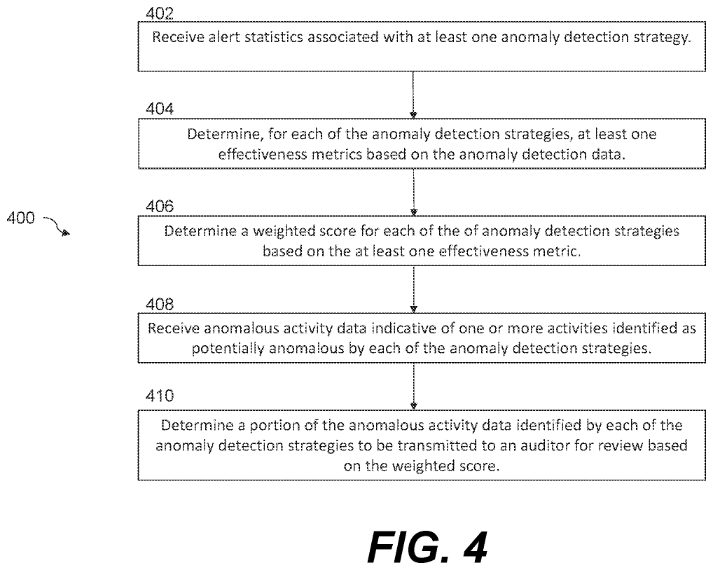

Referring now to FIG. 4, illustrated is a flow diagram of method 400 for detecting anomalous activity, in accordance with an embodiment of the present disclosure. Each of steps 402-410 of method 400 may be performed automatically by at least one processor, such as included in controller 600, associated with auditor assignment system(s) 115, anomaly detection engine 220, and/or weighting engine 240.

With continued reference to FIG. 4, method 400 includes, at step 402, receiving alert statistics 252 (see FIG. 2) associated with at least one anomaly detection strategy 320a-320f (see FIGS. 2 and 3) configured to identify anomalous activity. Alter statistics 252 associated with each of anomaly detection strategies 320a-320f may include, for example, historical data relating to the effectiveness of each of anomaly detection strategies 320a-320f. For example, alert statistics 252 may include historical data related to the effectiveness of each of anomaly detection strategies 320a-320f, such as number of detected activities that were true positive results (column 304 of FIG. 2), and a number of detected activities that were false positive results (column 306 of FIG. 2). In some embodiments, anomaly detection data may include ranking data associated with an order in which the results are presented to auditor(s) 140.

With continued reference to FIG. 4, method 400 includes, at step 404, determining for each of anomaly detection strategies 320a-320f, at least one effectiveness metric based on alert statistics 252. Effectiveness metrics may include, for example, hit rate and NDCG score as respectively illustrated in columns 308 and 310 of FIG. 3. Determining hit rate for each of anomaly detection strategies 320a-320f may be performed as described herein, namely by dividing the number of true positive results identified by a given anomaly detection strategy (column 304 of FIG. 3) by the total number of results identified by that anomaly detection strategy. For example, the hit rate for anomaly detection strategy 320a is equal to 18 divided by 201, or 8.96%.

Determining NDCG score for each of anomaly detection strategies 320a-320f may be performed as described herein, namely using Equations 1 to 3 as described above in connection with FIG. 3, based on the ranking data associated with a given anomaly detection strategy. For example, NDCG score for anomaly detection strategy 320a is 47.19%.

In some embodiments, determining the effectiveness metrics at step 404 may include calculating the effective metrics, by weighting engine 240, from other alert statistics 252 such as number of true positive and false positive results. In some embodiments, determining the effectiveness metrics at step 404 may include receiving, for example by weighting engine 140, pre-calculated effectiveness metrics from an external source.

With continued reference to FIG. 4, method 400 includes, at step 406, determining a weighted score for each of the anomaly detection strategies 320a-320f based on the at least one effectiveness metric. The weighted scores for anomaly detection strategies 320a-320f may represent the effectiveness of a particular anomaly detection strategy relative to the other anomaly detection strategies. For example, anomaly strategy 320b is more effective in terms of both hit rate (column 308 of FIG. 3) and NDCG (column 310) than anomaly strategy 320a, and therefore has a higher weighted score (31.64%) than the weighted score (17.21%) of anomaly detection strategy 320a.

In some embodiments, each of the effectiveness metrics 308, 310 may be weighted equally (e.g. 50:50) in determining the weighted score for each of anomaly detection strategies 320a-320f.

In the illustrated embodiment, the weighted scores are expressed as a percentage, such that the sum of the weighted scores of all of anomaly detection strategies 320a-320f is equal to 100%. However, the weighted scores may be expressed in substantially any manner that facilities relativistic comparison between the weighted scores of various anomaly detection strategies 320a-320f.

With continued reference to FIG. 4, method 400 includes, at step 408, receiving anomalous activity data 222 (see FIG. 2) indicative of one or more activities identified as potentially anomalous by each of anomaly detection strategies 320a-320f. The anomalous activity data 222 includes data associated with transaction data 212 that meets one or more criterion indicative of an anomalous activity, as determined by anomaly detection strategies 320a-320f. As described herein, each of anomaly detection strategies 320a-320f may be configured to identify a different criterion, or combinations of criteria, in transaction data 212 to identify activity that is potentially anomalous. The anomalous activity data 222 thus includes those activities which one or more of anomaly detection strategies 320a-320f identified as being potentially anomalous, based on the particular criteria that each anomaly detection strategies 320a-320f utilizes to identify anomalous activity. In some embodiments, each of anomaly detection strategies 320a-320f may review a different portion of transaction data 212. In other embodiments, at least two of anomaly detection strategies 320a-320f may review the same transaction data 212.

With continued reference to FIG. 4, method 400 includes, at step 410, determining a portion of the anomalous activity data 322 identified by each of anomaly detection strategies 320a-320f to be transmitted to auditor(s) 140 (see FIGS. 1 and 2) for review. More particularly, the portion of anomalous activity data 322 is transmitted to user device(s) 105 associated with auditor(s) 140. User device(s) 150 may present the portion of the anomalous activity data 322 in the form of a list including a predetermined number (n) of results that auditor(s) 140 should review for anomalies.

The portion of potentially anomalous activity data 222 to be transmitted may be proportional to the weighted score of the respective anomaly detection strategy. As described herein, the weighted scores (column 312 of FIG. 2) may be presented as a percentage, which facilitates simple calculation of the results in step 410. That is, the total number of results to be transmitted to auditor(s) 140 may be multiplied by the weightage score of each anomaly detection strategies 320a-320f to determine how many of the results associated with that anomaly detection strategy are transmitted to the auditor. For example, if auditor(s) 140 is to review 10 total results, the portion of those results associated with anomaly detection strategy 320a is equal to 10 multiplied by the weighted score (17.21%), or 1.7 results (which is rounded to the nearest whole number, 2). Thus, two (2) results from sub-database 330 (a) (see FIG. 2) is transmitted to auditor(s) 140.

Similarly, the portion of potentially anomalous activities identified by anomaly detection strategy 320b to be transmitted are transmitted to auditor(s) 140 is three (3) (31.64% of 10, rounded to the nearest whole number). Thus three (3) records from sub-database 330b are transmitted to auditor(s) 140. Similarly, the portion of potentially anomalous activities identified by anomaly detection strategy 320c is two (2) (16.02 of 10, rounded to the nearest whole number). Thus, two (2) records from sub-database 330c is transmitted to auditor(s) 140.

Step 410 optimizes use of both human and computational resources in environment 100. As described herein, those anomaly detection strategies 320a-320f that are more effective supply a disproportionate amount of potentially anomalous activity for auditor(s) 140 to review, which leads to auditor(s) spending more time reviewing potentially anomalous activity that is more likely to include actually anomalous activity (i.e. true positive results). Particularly where the amount of potentially anomalous activity is too great to review all records, the NDCG score component of the weighted score ensures that those of results transmitted to auditor(s) 140 for review include a disproportionate number of true positive results. Furthermore, system components use less computational resources transmitting data relating to activity that is not anomalous.

In some instances, the calculated portion of results to be transmitted for a particular anomaly detection strategy to transmit to auditor(s) 140 may be zero. This will occur if an anomaly strategy has a weighted score of zero (e.g., anomaly detection strategies 320d and 320f in the illustrated example), or if the calculated portion of results rounds to zero. In some embodiments, one (1) potentially anomalous activity identified by that anomaly detection strategy 320 is transmitted to auditor(s) 140 in such instances. In the illustrated example, one (1) record from each of databases 330d and 330f are transmitted to auditor(s) 140, despite respective anomaly detection strategies 320d and 320f having a weighted score of zero (0). Thus, each anomaly detection strategy 320a-320f supplies at least one potentially anomalous activity to auditor(s) 140 at step 410.

In some embodiments, the portion of results to be transmitted for each anomaly detection strategy 320a-320f may be adjusted so that the sum of results from each sub-database 330a-330f is equal to the desired total number of results transmitted. For example, if rounding of results causes the sum of results from sub-databases 330a-330f to exceed the desired number of results to transmit to the auditor, the portions from one or more of sub-databases 330a-330f may be adjusted appropriately.

Step 410 may be repeated for each of auditor 140 reviewing potentially anomalous activity. The number of total results transmitted to each auditor 140 may be determined based on the total number of results to be reviewed and the number of auditors. For example, if 200 total results are to be reviewed by 20 auditors, each auditor 140 may review 10 results.

As is apparent from the description of step 410, anomaly detection strategies having relatively higher weightage scores will have a larger portion of results transmitted to the auditor(s) 140. Thus, those anomaly detection strategies that are more likely to identify true positive results of anomalous activity (i.e. those anomaly detection strategies having higher weighted scores) are more heavily relied upon for transmitting potentially anomalous activity to auditor(s) 140. As such auditor(s) 140 spends more time reviewing anomalous activity data 322 that is more likely to include anomalous activity.

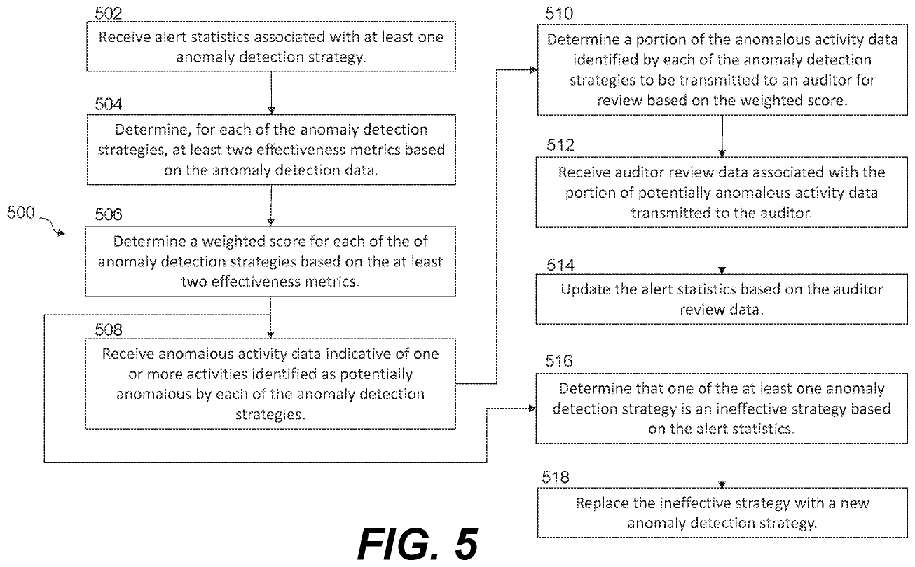

Referring now to FIG. 5, illustrated is a flow diagram of method 500 for detecting anomalous activity, in accordance with an embodiment of the present disclosure. Each of steps 502-518 of method 500 may be performed automatically by at least one processor, such as included in controller 600, associated with auditor assignment system(s) 115, anomaly detection engine 220, and/or weighting engine 240.

Method 500 includes, at step 502, receiving alert statistics 252 (see FIG. 2) associated with at least one anomaly detection strategy 320a-320f (see FIGS. 2 and 3) configured to identify anomalous activity. Method 500 further includes, at step 504, determining for each of anomaly detection strategies 320a-320f, at least two effectiveness metrics based on alert statistics 252. Method 500 further includes, at step 506, determining a weighted score for each of anomaly detection strategies 320a-320f based on the at least two effectiveness metrics. Method 500 further includes, at step 508, receiving anomalous activity data 222 indicative of one or more activities identified as potentially anomalous by each of anomaly detection strategies 320a-320f. Method 500 further includes, at step 510, determining a portion of the anomalous activity data 322 identified by each of anomaly detection strategies 320a-320f to be transmitted to auditor(s) 140 (see FIGS. 1 and 2) for review. Each of steps 502-510 of method 500 may be substantially identical to respective steps 402-410 of method 400, except that the at least one effectiveness metric determined in step 404 of method 400 becomes at least two effectiveness metrics in step 504 of method 500.

With continued reference to FIG. 5, method 500 further includes, at step 512, receiving auditor review data associated with the portion of potentially anomalous activity data 222 transmitted to auditor(s) 140. Auditor review data includes determinations by auditor(s) 140 that the potentially anomalous activities transmitted to auditor(s) 140 at step 510 is/are true positive result(s) and/or false positive result(s). Auditor review data thus indicates whether the potentially anomalous activity identified by anomaly detection strategies 320a-320f was actually anomalous. Auditor review data may be received from user device(s) 105 associated with auditor(s) 140.

With continued reference to FIG. 5, method 500 further includes, at step 514, updating alert statistics 252 based on the auditor review data. That is, alert statistics 252 associated with each anomaly detection strategy 320a-320f are updated to reflect the auditor review data. For example, if auditor(s) 140 determines that a result identified by anomaly detection strategy 320a is a true positive result, the number of true positive results in column 304 of table 300 (see FIG. 3) will be incremented by one, and hit rate (column 308) and NDCG score (column 310) will be recalculated accordingly. As a result of performing step 514, alert statistics 252 reflect the most recent reviewing activity by auditor(s) 140. In some embodiments, alert statistics 252 may be weighted towards the most recent auditor review data so that alert statistics 252 reflects current trends in the effectiveness of anomaly detection strategies 320a-320f.

Upon completion of step 514, method 500 may be repeated, with the updated the alert statistics from step 514 being received at the next iteration of step 502. Thus, the portion of activity data to be transmitted to auditor(s) 140 at step 510 is based on the updated alter statistics.

With continued reference to FIG. 5, method 500 may further include, at step 516, determining that one of the at least one anomaly detection strategies 320a-320f is an ineffective strategy based on alert statistics 252 and/or the weighted score determined at step 506. An ineffective strategy may be a strategy with one or more alert statistics 252 falling below a predetermined threshold, indicating that the ineffective strategy is not identifying true anomalous activity at sufficient frequency to justify continued use of the ineffective strategy. For example, anomaly detection strategy 320f may be determined to be ineffective based on 0% hit rate, 0% NDCG score, and/or 0% weighted score (as shown in table 300 of FIG. 3).

With continued reference to FIG. 5, method 500 may further include, at step 518, replacing the ineffective strategy with a new anomaly detection strategy. The new anomaly detection strategy may be more effective, based on the alert statistics 252 and/or a calculated weighted score, than the ineffective strategy. Replacing the ineffective strategy optimizes both human and computation resource allocation. Auditor time spent reviewing activity that is not actually anomalous (i.e. false positives results) is reduced. Computational resources (e.g. memory and processing power) are likewise not spent transmitting data between system components that is not actually anomalous.

Steps 516 and 18 may be performed at substantially any time during performance of method 500, such as prior to step 502, prior to step 508 (as illustrated in FIG. 5), or subsequent to step 514.

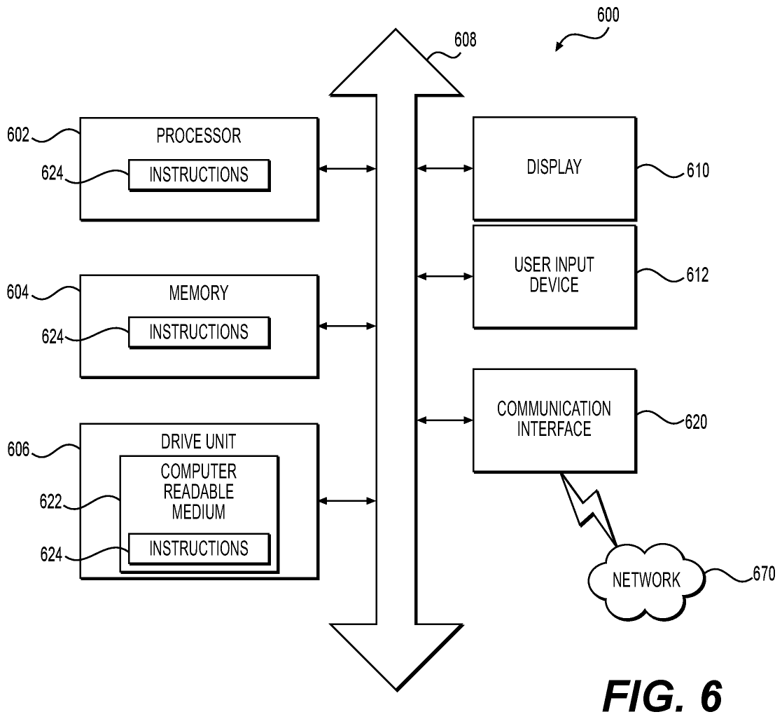

FIG. 6 depicts an implementation of a controller 600 that may execute techniques presented herein, according to one or more embodiments. The controller 600 may include a set of instructions that can be executed to cause the controller 600 to perform any one or more of the methods or computer based functions disclosed herein. The controller 600 may operate as a standalone device or may be connected, e.g., using a network, to other computer systems or peripheral devices.

In a networked deployment, the controller 600 may operate in the capacity of a server or as a client in a server-client user network environment, or as a peer computer system in a peer-to-peer (or distributed) network environment. The controller 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a headset, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 600 can be implemented using electronic devices that provide voice, video, or data communication. Further, while the controller 600 is illustrated as a single system, the term “system” shall also be taken to include any collection of systems or sub-systems that individually or jointly execute a set, or multiple sets, of instructions to perform one or more computer functions.

As illustrated in FIG. 6, the controller 600 may include at least one processor 602, e.g., a central processing unit (CPU), a graphics processing unit (GPU), or both. The processor 602 may be a component in a variety of systems. For example, the processor 602 may be part of a standard computer. The processor 602 may be one or more general processors, digital signal processors, application specific integrated circuits, field programmable gate arrays, servers, networks, digital circuits, analog circuits, combinations thereof, or other now known or later developed devices for analyzing and processing data. The processor 602 may implement a software program, such as code generated manually (i.e., programmed).

The controller 600 may include a memory 604 that can communicate via a bus 608. The memory 604 may be a main memory, a static memory, or a dynamic memory. The memory 604 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 604 includes a cache or random-access memory for the processor 602. In alternative implementations, the memory 604 is separate from the processor 602, such as a cache memory of a processor, the system memory, or other memory. The memory 604 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 604 is operable to store instructions executable by the processor 602. The functions, acts or tasks illustrated in the figures or described herein may be performed by the processor 602 executing the instructions stored in the memory 604. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the controller 600 may further include a display 610, such as a liquid crystal display (LCD), an organic light emitting diode (OLED), a flat panel display, a solid-state display, a cathode ray tube (CRT), a projector, a printer or other now known or later developed display device for outputting determined information. The display 610 may act as an interface for the user to see the functioning of the processor 602, or specifically as an interface with the software stored in the memory 604 or in the drive unit 606.

Additionally or alternatively, the controller 600 may include an input device 612 configured to allow a user to interact with any of the components of controller 600. The input device 612 may be a number pad, a keyboard, or a cursor control device, such as a mouse, or a joystick, touch screen display, remote control, headset, or any other device operative to interact with the controller 600.

The controller 600 may also or alternatively include drive unit 606 implemented as a disk or optical drive. The drive unit 606 may include a computer-readable medium 622 in which one or more sets of instructions 624, e.g. software, can be embedded. Further, the instructions 624 may embody one or more of the methods or logic as described herein. The instructions 624 may reside completely or partially within the memory 604 and/or within the processor 602 during execution by the controller 600. The memory 604 and the processor 602 also may include computer-readable media as discussed above.

In some systems, a computer-readable medium 622 includes instructions 624 or receives and executes instructions 624 responsive to a propagated signal so that a device connected to a network 670 can communicate voice, video, audio, images, or any other data over the network 670. Further, the instructions 624 may be transmitted or received over the network 670 via a communication port or interface 620, and/or using a bus 608. The communication port or interface 620 may be a part of the processor 602 or may be a separate component. The communication port or interface 620 may be created in software or may be a physical connection in hardware. The communication port or interface 620 may be configured to connect with a network 670, external media, the display 610, or any other components in controller 600, or combinations thereof. The connection with the network 670 may be a physical connection, such as a wired Ethernet connection or may be established wirelessly as discussed below. Likewise, the additional connections with other components of the controller 600 may be physical connections or may be established wirelessly. The network 670 may alternatively be directly connected to a bus 608.

While the computer-readable medium 622 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 622 may be non-transitory, and may be tangible.

The computer-readable medium 622 can include a solid-state memory such as a memory card or other package that houses one or more non-volatile read-only memories. The computer-readable medium 622 can be a random-access memory or other volatile re-writable memory. Additionally or alternatively, the computer-readable medium 622 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 600 may be connected to a network 670. The network 670 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 670 may include wide area networks (WAN), such as the Internet, local area networks (LAN), campus area networks, metropolitan area networks, a direct connection such as through a Universal Serial Bus (USB) port, or any other networks that may allow for data communication. The network 670 may be configured to couple one computing device to another computing device to enable communication of data between the devices. The network 670 may generally be enabled to employ any form of machine-readable media for communicating information from one device to another. The network 670 may include communication methods by which information may travel between computing devices. The network 670 may be divided into sub-networks. The sub-networks may allow access to all of the other components connected thereto or the sub-networks may restrict access between the components. The network 670 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for detecting anomalous activity, the method comprising:
receiving, by at least one processor, alert statistics associated with at least one anomaly detection strategy configured to identify anomalous activity in transaction records;
determining, by at least one processor, for each of the anomaly detection strategies, at least one effectiveness metric based on the alert statistics;
determining, by at least one processor, a weighted score for each of the anomaly detection strategies based on the at least one effectiveness metric;
receiving, by at least one processor, anomalous activity data indicative of one or more activities identified as potentially anomalous by each of the anomaly detection strategies; and
determining, by at least one processor, a portion of the anomalous activity data identified by each of the anomaly detection strategies to be transmitted to an auditor for review based on the weighted score,
wherein the portion of potentially anomalous activities to be transmitted is substantially proportional to the weighted score for each of the anomaly detection strategies.

2. The method of claim 1, wherein the at least one effectiveness metric includes normalized discounted cumulative gain score representative of ranking quality of an anomaly detection strategy.

3. The method of claim 2, wherein the at least one effective metric includes hit rate representative of a rate at which an anomaly detection strategy identifies true positive results.

4. The method of claim 1, wherein a number of potentially anomalous activities to be reviewed is at least one for each of the anomaly detection strategies.

5. The method of claim 1, wherein the alert statistics for each of the anomaly detection strategies comprise at least one of:
a number of true positive results identified by each of the anomaly detection strategies;
a number of false positive results identified by each of the anomaly detection strategies; and
rankings of the results identified by each of the anomaly detection strategies.

6. The method of claim 1, further comprising:
receiving, by at least one processor, auditor review data associated with the portion of potentially anomalous activities transmitted to the auditor; and
updating, by at least one processor, the alert statistics based on the auditor review data.

7. The method of claim 1, further comprising:
determining, by at least one processor, that one of the at least one anomaly detection strategies is an ineffective strategy based on the alert statistics; and
replacing, by at least one processor, the ineffective strategy with a new anomaly detection strategy.

8. A computer system for detecting anomalous activity, the computer system comprising:
at least one memory having processor-readable instructions stored therein; and
at least one processor configured to access the memory and execute the processor-readable instructions, which when executed by the processor configure the processor to perform a plurality of functions, including functions for:
receiving alert statistics associated with at least one anomaly detection strategy configured to identify anomalous activity in transaction records;
determining, for each of the anomaly detection strategies, at least one effectiveness metric based on the alert statistics;
determining a weighted score for each of the anomaly detection strategies based on the at least one effectiveness metric;
receiving anomalous activity data indicative of one or more activities identified as potentially anomalous by each of the anomaly detection strategies; and
determining a portion of the anomalous activity data identified by each of the anomaly detection strategies to be transmitted to an auditor for review based on the weighted score,
wherein the portion of potentially anomalous activities to be transmitted is substantially proportional to the weighted score for each of the anomaly detection strategies.

9. The computer system of claim 8, wherein the at least one effectiveness metric includes normalized discounted cumulative gain score representative of ranking quality of an anomaly detection strategy.

10. The computer system of claim 9, wherein the at least one effectiveness metric includes hit rate representative of a rate at which an anomaly detection strategy identifies true positive results.

11. The computer system of claim 8, wherein a number of potentially anomalous activities to be reviewed is at least one for each of the anomaly detection strategies.

12. The computer system of claim 8, wherein the alert statistics for each of the anomaly detection strategies comprise at least one of:
a number of true positive results identified by each of the anomaly detection strategies;
a number of false positive results identified by each of the anomaly detection strategies; and
rankings of the results identified by each of the anomaly detection strategies.

13. The computer system of claim 8, wherein the plurality of functions further include:
receiving auditor review data associated with the portion of potentially anomalous activities transmitted to the auditor; and
updating the alert statistics based on the auditor review data.

14. The computer system of claim 8, wherein the plurality of functions further include:
determining that one of the at least one anomaly detection strategies is an ineffective strategy based on the alert statistics; and
replacing the ineffective strategy with a new anomaly detection strategy.

15. A non-transitory computer-readable medium containing instructions for detecting anomalous activity, the non-transitory computer-readable medium storing instructions that, when executed by at least one processor, configure the at least one processor to perform:
receiving alert statistics associated with at least one anomaly detection strategy configured to identify anomalous activity in transaction records;
determining, for each of the anomaly detection strategies, at least one effectiveness metric based on the alert statistics;
determining a weighted score for each of the anomaly detection strategies based on the at least one effectiveness metric;
receiving, by at least one processor, anomalous activity data indicative of one or more activities identified as potentially anomalous by each of the anomaly detection strategies; and
determining, by at least one processor, a portion of the anomalous activity data identified by each of the anomaly detection strategies to be transmitted to an auditor for review based on the weighted score,
wherein the portion of potentially anomalous activities to be transmitted is substantially proportional to the weighted score for each of the anomaly detection strategies.

16. The computer-readable medium of claim 15, wherein the at least one effectiveness metric includes normalized discounted cumulative gain score representative of ranking quality of an anomaly detection strategy.

17. The computer-readable medium of claim 16, wherein the at least one effectiveness metric includes hit rate representative of a rate at which an anomaly detection strategy identifies true positive results.

18. The computer-readable medium of claim 15, wherein a number of potentially anomalous activities to be reviewed is at least one for each of the anomaly detection strategies.

19. The computer-readable medium of claim 15, wherein the instructions further configure the at least one processor to perform:
receiving auditor review data associated with the portion of potentially anomalous activities transmitted to the auditor; and
updating the alert statistics based on the auditor review data.

20. The computer-readable medium of claim 15, wherein the instructions further configure the at least one processor to perform:
determining that one of the at least one anomaly detection strategies is an ineffective strategy based on the alert statistics; and
replacing the ineffective strategy with a new anomaly detection strategy.
